(19) United States
(12) Patent Application Publication
(10) Pub. No.: US 2009/0310027 A1
(43) Pub. Date: Dec. 17, 2009

(54) SYSTEMS AND METHODS FOR SEPARATE AUDIO AND VIDEO LAG CALIBRATION IN A VIDEO GAME

(76) Inventor: James Fleming, Brighton, MA (US)

Correspondence Address: PROSKAUER ROSE LLP, ONE INTERNATIONAL PLACE, BOSTON, MA, 02110, US

(21) Appl. No.: 12/139,971

(22) Filed: Jun. 16, 2008

(51) Int. Cl. H04N 5/268; G06F 17/00

(52) U.S. Cl. 348/706; 463/43

(57) ABSTRACT

Systems and methods for adjusting the relative timing of audio and video signals of a video game responsive to a lag differential between an audio system and a video system connected to a game platform are described. In one embodiment, a method includes determining, by a game platform, a difference between an audio lag of an audio system connected to the game platform and a video lag of a video system connected to the game platform. The game platform may then transmit an audio signal and a video signal, wherein the relative timing of the audio signal to the video signal is reflective of the determined difference. The difference between the audio lag and video lag may be measured directly, or the audio and video lag may each be measured separately.

### FIELD OF THE INVENTION

The present invention relates to video games and, more specifically, calibrating video games for various audio and video systems.

### BACKGROUND OF THE INVENTION

Music making is often a collaborative effort among many musicians who interact with each other. One form of musical interaction may be provided by a video game genre known as “rhythm-action,” which requires a player to perform phrases from a pre-recorded musical composition using the video game's input device to simulate a musical instrument. If the player performs a sufficient percentage of the notes displayed, he may score well and win the game. If the player fails to perform a sufficient percentage of the notes displayed, he may score poorly and lose the game. Two or more players may compete against each other, such as by each one attempting to play back different, parallel musical phrases from the same song simultaneously, by playing alternating musical phrases from a song, or by playing similar phrases simultaneously. The player who plays the highest percentage of notes correctly may achieve the highest score and win. Two or more players may also play with each other cooperatively. In this mode, players may work together to play a song, such as by playing different parts of a song, either on similar or dissimilar instruments. One example of a rhythm-action game is the GUITAR HERO series of games published by Red Octane and Activision.

A rhythm action-game may require precise synchronization between a player's input and the sounds and display of the game. Past rhythm action games for game platforms have included a lag calibration option in which players may calibrate a lag value representing an offset between the time the a/v signal is sent from the platform to the time it is observed by the player.

### SUMMARY OF THE INVENTION

Broadly speaking, the present invention relates to the realization that for game platforms, the lag introduced by external audio systems for the audio signal may be different from the lag introduced for the video signal by external systems. This may result in the user perceiving audio and video events that are improperly synchronized. This difference in lags may result from any number of causes. For example, a player may use separate devices for audio and video, such as connecting their game platform to a stereo system for audio output, while using a projection TV for video output. Or, for example, a player may connect their game platform to a television which processes and emits audio signals faster than video signals are processed and displayed. These differences in lag values may be substantial enough to interfere with a player's experience of a video game-sounds not being played synchronously with corresponding video events may cause uncertainty on the part of a player as to when appropriate input is required. The present invention relates to systems and methods for addressing this potential problem by determining individual values for audio lag and video lag and compensating accordingly. This improved calibration may contribute to the enjoyment of rhythm action games, such as the ROCK BAND game published by Electronic Arts.

In one aspect, the present invention relates to a method for adjusting the relative timing of audio and video signals of a video game responsive to a lag differential between an audio system and a video system connected to a game platform. In one embodiment, a method includes determining, by a game platform, a difference between an audio lag of an audio system connected to the game platform and a video lag of a video system connected to the game platform. The game platform may then transmit an audio signal and a video signal, wherein the relative timing of the audio signal to the video signal is reflective of the determined difference. The difference between the audio lag and video lag may be measured directly, or the audio and video lag may each be measured separately.

In another aspect, the present invention relates to a computer readable program product for adjusting the relative timing of audio and video signals of a video game responsive to a lag differential between an audio system and a video system connected to a game platform. In one embodiment, the computer program product includes: executable code for determining, by a game platform, a difference between an audio lag of an audio system connected to the platform and a video lag of a video system connected to the platform; and executable code for transmitting, by the game platform, an audio signal and a video signal, wherein the relative timing of the audio signal to the video signal is reflective of the determined difference.

### BRIEF DESCRIPTION OF THE DRAWINGS

The foregoing and other objects, aspects, features, and advantages of the invention will become more apparent and better understood by referring to the following description taken in conjunction with the accompanying drawings, in which:

FIG. 1A is an example screenshot of one embodiment of a multiplayer rhythm-action game;

FIG. 1B is a second example screenshot of one embodiment of a multiplayer rhythm-action game;

FIG. 1C is a block diagram of a system facilitating network play of a rhythm action game;

FIG. 1D is an example screenshot of one embodiment of network play of a rhythm action game;

FIG. 2 is a block diagram of an example of a game platform connected to an audio/video system;

FIG. 3 is a flow diagram of two embodiments of methods for adjusting the relative timing of audio and video signals of a video game responsive to a lag differential between an audio system and a video system connected to a game platform;

FIG. 4 illustrates example timelines illustrating one embodiment of transmitting an audio signal and a video signal, wherein the relative timing of the audio signal to the video signal is reflective of a determined lag difference

FIG. 5A is an example calibration screen in which a user is prompted to specify a relationship between a played sound and a displayed image;

FIG. 5B is an example calibration screen in which a user is prompted to perform an action synchronously with both a displayed image and a played sound; and

FIG. 6 is a block diagram of one embodiment of a process for lag calibration using a guitar controller 260 with an embedded audio sensor 620 and video sensor 630.

### DETAILED DESCRIPTION

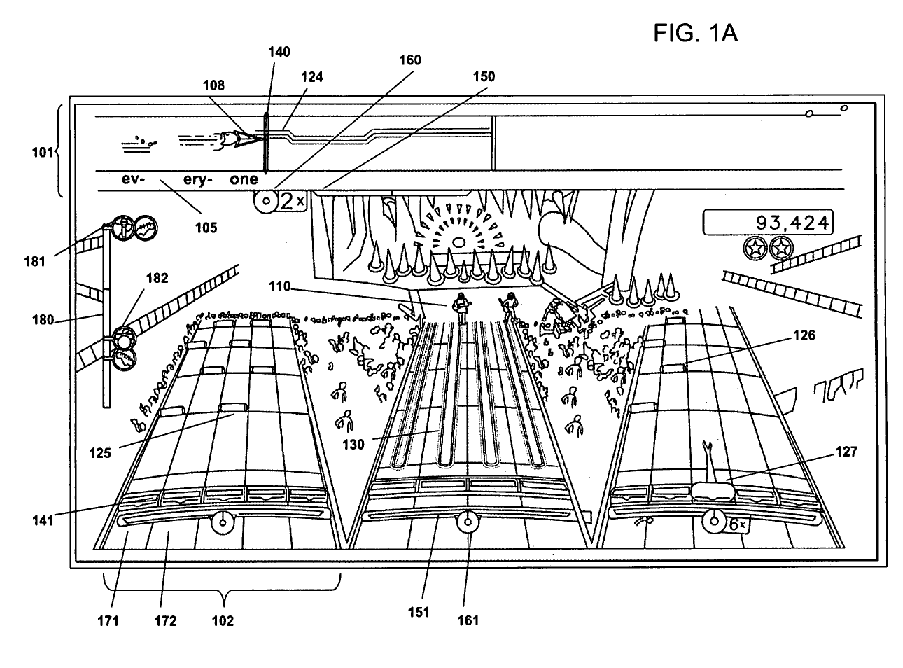

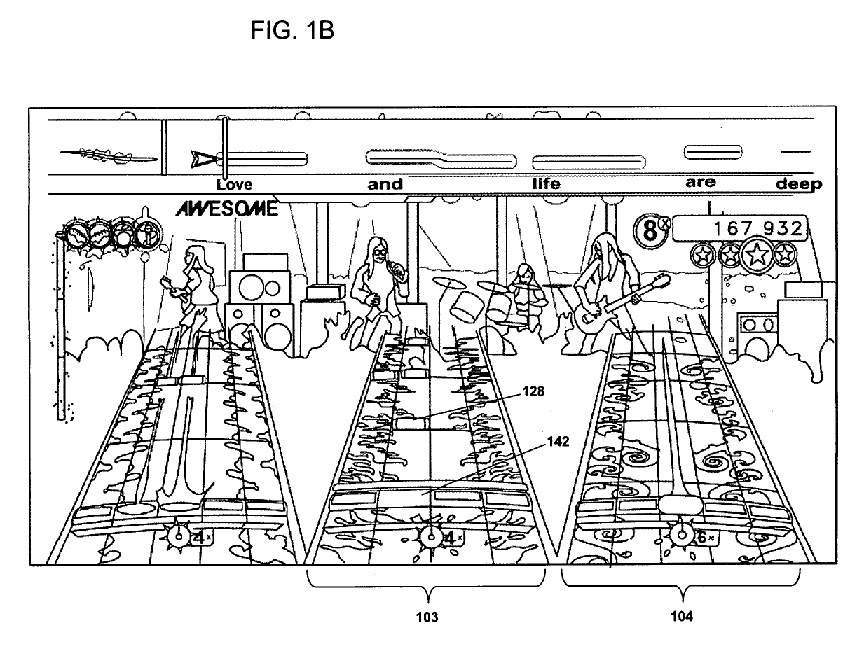

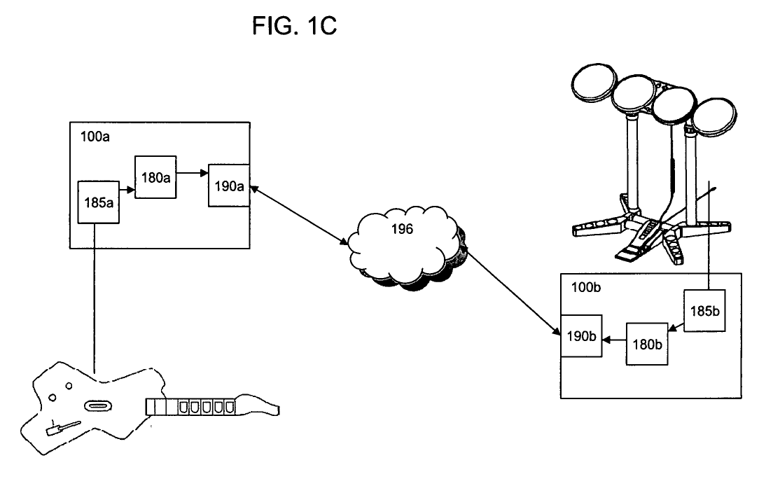

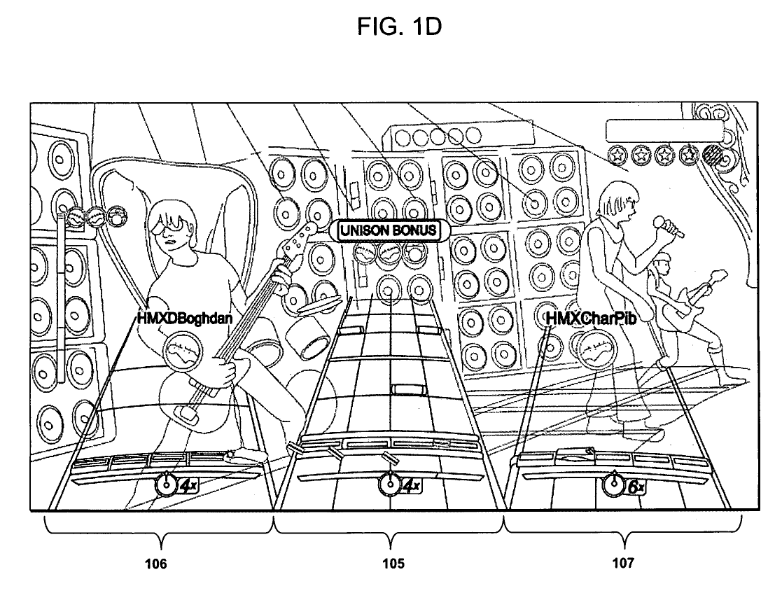

Referring now to FIG. 1A, an embodiment of a screen display for a video game in which four players emulate a musical performance is shown. One or more of the players may be represented on screen by an avatar 110. Although FIG. 1A depicts an embodiment in which four players participate, any number of players may participate simultaneously. For example, a fifth player may join the game as a keyboard player. In this case, the screen may be further subdivided to make room to display a fifth avatar and/or music interface. In some embodiments, an avatar 110 may be a computer-generated image. In other embodiments, an avatar may be a digital image, such as a video capture of a person. An avatar may be modeled on a famous figure or, in some embodiments, the avatar may be modeled on the game player associated with the avatar.

Still referring to FIG. 1A, a lane 101 102 has one or more game “cues” 124, 125, 126, 127, 130 corresponding to musical events distributed along the lane. During gameplay, the cues, also referred to as “musical targets,” “gems,” or “game elements,” appear to flow toward a target marker 140, 141. In some embodiments, the cues may appear to be flowing towards a player. The cues are distributed on the lane in a manner having some relationship to musical content associated with the game level. For example, the cues may represent note information (gems spaced more closely together for shorter notes and further apart for longer notes), pitch (gems placed on the left side of the lane for notes having lower pitch and the right side of the lane for higher pitch), volume (gems may glow more brightly for louder tones), duration (gems may be “stretched” to represent that a note or tone is sustained, such as the gem 127), articulation, timbre or any other time-varying aspects of the musical content. The cues may be any geometric shape and may have other visual characteristics, such as transparency, color, or variable brightness.

As the gems move along a respective lane, musical data represented by the gems may be substantially simultaneously played as audible music. In some embodiments, audible music represented by a gem is only played (or only played at full or original fidelity) if a player successfully “performs the musical content” by capturing or properly executing the gem. In some embodiments, a musical tone is played to indicate successful execution of a musical event by a player. In other embodiments, a stream of audio is played to indicate successful execution of a musical event by a player. In certain embodiments, successfully performing the musical content triggers or controls the animations of avatars.

In other embodiments, the audible music, tone, or stream of audio represented by a cue is modified, distorted, or otherwise manipulated in response to the player's proficiency in executing cues associated with a lane. For example, various digital filters can operate on the audible music, tone, or stream of audio prior to being played by the game player. Various parameters of the filters can be dynamically and automatically modified in response to the player capturing cues associated with a lane, allowing the audible music to be degraded if the player performs poorly or enhancing the audible music, tone, or stream of audio if the player performs well. For example, if a player fails to execute a game event, the audible music, tone, or stream of audio represented by the failed event may be muted, played at less than full volume, or filtered to alter the sound.

In certain embodiments, a “wrong note” sound may be substituted for the music represented by the failed event. Conversely, if a player successfully executes a game event, the audible music, tone, or stream of audio may be played normally. In some embodiments, if the player successfully executes several, successive game events, the audible music, tone, or stream of audio associated with those events may be enhanced, for example, by adding an echo or “reverb” to the audible music. The filters can be implemented as analog or digital filters in hardware, software, or any combination thereof. Further, application of the filter to the audible music output, which in many embodiments corresponds to musical events represented by cues, can be done dynamically, that is, during play. Alternatively, the musical content may be processed before game play begins. In these embodiments, one or more files representing modified audible output may be created and musical events to output may be selected from an appropriate file responsive to the player's performance.

In addition to modification of the audio aspects of game events based on the player's performance, the visual appearance of those events may also be modified based on the player's proficiency with the game. For example, failure to execute a game event properly may cause game interface elements to appear more dimly. Alternatively, successfully executing game events may cause game interface elements to glow more brightly. Similarly, the player's failure to execute game events may cause their associated avatar to appear embarrassed or dejected, while successful performance of game events may cause their associated avatar to appear happy and confident. In other embodiments, successfully executing cues associated with a lane causes the avatar associated with that lane to appear to play an instrument. For example, the drummer avatar will appear to strike the correct drum for producing the audible music. Successful execution of a number of successive cues may cause the corresponding avatar to execute a “flourish,” such as kicking their leg, pumping their first, performing a guitar “windmill,” spinning around, winking at the “crowd,” or throwing drum sticks.

Player interaction with a cue may be required in a number of different ways. In general, the player is required to provide input when a cue passes under or over a respective one of a set of target markers 140, 141 disposed on the lane. For example, the player associated with lane 102 (lead guitar) may use a specialized controller to interact with the game that simulates a guitar, such as a Guitar Hero SG Controller, manufactured by RedOctane of Sunnyvale, Calif. In this embodiment, the player executes the cue by activating the “strum bar” while pressing the correct fret button of the controller when the cue 125 passes under the target marker 141. In other embodiments, the player may execute a cue by performing a “hammer on” or “pull off,” which requires quick depression or release of a fret button without activation of the strum bar. In other embodiments, the player may be required to perform a cue using a “whammy bar” provided by the guitar controller. For example, the player may be required to bend the pitch of note represented by a cue using the whammy bar. In some embodiments, the guitar controller may also use one or more “effects pedals,” such as reverb or fuzz, to alter the sound reproduced by the gaming platform.

In other embodiments, player interaction with a cue may comprise singing a pitch and or a lyric associated with a cue. For example, the player associated with lane 101 may be required to sing into a microphone to match the pitches indicated by the gem 124 as the gem 124 passes over the target marker 140. As shown in FIG. 1A, the notes of a vocal track are represented by “note tubes” 124. In the embodiment shown in FIG. 1A, the note tubes 124 appear at the top of the screen and flow horizontally, from right to left, as the musical content progresses. In this embodiment, vertical position of a note tube 124 represents the pitch to be sung by the player; the length of the note tube indicates the duration for which the player must hold that pitch. In other embodiments, the note tubes may appear at the bottom or middle of the screen. The arrow 108 provides the player with visual feedback regarding the pitch of the note that is currently being sung. If the arrow is above the note tube 124, the player needs to lower the pitch of the note being sung. Similarly, if the arrow 108 is below the note tube 124, the player needs to raise the pitch of the note being sung. In these embodiments, the vocalist may provide vocal input using a USB microphone of the sort manufactured by Logitech International of Switzerland. In other embodiments, the vocalist may provide vocal input using another sort of simulated microphone. In still further embodiments, the vocalist may provide vocal input using a traditional microphone commonly used with amplifiers. As used herein, a “simulated microphone” is any microphone apparatus that does not have a traditional XLR connector. As shown in FIG. 1A, lyrics 105 may be provided to the player to assist their performance.

In still other embodiments, a player interaction with a cue may comprise any manipulation of any simulated instrument and/or game controller.

As shown in FIG. 1A, each lane may be subdivided into a plurality of segments. Each segment may correspond to some unit of musical time, such as a beat, a plurality of beats, a measure, or a plurality of measures. Although the embodiment shown in FIG. 1A show equally-sized segments, each segment may have a different length depending on the particular musical data to be displayed. In addition to musical data, each segment may be textured or colored to enhance the interactivity of the display. For embodiments in which a lane comprises a tunnel or other shape (as described above), a cursor is provided to indicate which surface is “active,” that is, with which lane surface a player is currently interacting. In these embodiments, the viewer can use an input device to move the cursor from one surface to another. As shown in FIG. 1A, each lane may also be divided into a number of sub-lanes, with each sub-lane containing musical targets indicating different input elements. For example, the lane 102 is divided into five sub-lanes, including sub-lanes 171 and 172. Each sub-lane may correspond to a different fret button on the neck of a simulated guitar.

Referring now to FIG. 1B, a second embodiment of a screen display for a video game in which four players emulate a musical performance is shown. In the embodiment shown, the lanes 102 103 have graphical designs corresponding to gameplay events. For example, lane 103 comprises a flame pattern, which may correspond to a bonus activation by the player. For example, lane 104 comprises a curlicue pattern, which may correspond to the player achieving the 6× multiplier shown.

In other embodiments, a game display may alternate the display of one or more avatars and/or the display of the band as a whole. For example, during the performance of a song, a display may switch between a number of camera angle providing, for example, close-ups of the guitarist, bassist, drummer, or vocalist, shots of the band as a whole, shots of the crowd, and/or any combination of the avatars, stage, crowd, and instruments. In some embodiments, the sequence and timing of camera angles may be selected to resemble a music video. In some embodiments, the camera angles may be selected to display an avatar of a player who is performing a distinctive portion of a song. In other embodiments the camera angles may be selected to display an avatar of a player who is performing particularly well or poorly. In some embodiments, an avatar's gestures or actions may correspond to the current camera angle. For example, an avatar may have certain moves, such as a jump, head bang, devil horns, special dance, or other move, which are performed when a close-up of the avatar is shown. In some embodiments, the avatars motions may be choreographed to mimic the actual playing of the song. For example, if a song contains a section where the drummer hits a cymbal crash, the drummer avatar may be shown to hit a cymbal crash at the correct point in the song.

In some embodiments, avatars may interact with the crowd at a avenue, and camera angles may correspond to the interaction. For example, in one camera angle, an avatar may be shown pointing at various sections of the crowd. In the next camera angle the various sections of the crowd may be shown screaming, waving, or otherwise interacting with the avatar. In other embodiments, avatars may interact with each other. For example, two avatars may lean back-to-back while performing apportion of a song. Or for example, the entire band may jump up and land simultaneously, and stage pyrotechnics may also be synchronized to the band's move.

In some embodiments, the “lanes” containing the musical cues to be performed by the players may be on screen continuously. In other embodiments one or more lanes may be removed in response to game conditions, for example if a player has failed a portion of a song, or if a song contains an extended time without requiring input from a given player.

Although depicted in FIGS. 1A and 1B, in some embodiments (not shown), instead of a lane extending from a player's avatar, a three-dimensional “tunnel” comprising a number of lanes extends from a player's avatar. The tunnel may have any number of lanes and, therefore, may be triangular, square, pentagonal, sextagonal, septagonal, octagonal, nonanogal, or any other closed shape. In still other embodiments, the lanes do not form a closed shape. The sides may form a road, trough, or some other complex shape that does not have its ends connected. For ease of reference throughout this document, the display element comprising the musical cues for a player is referred to as a “lane.”

In some embodiments, a lane does not extend perpendicularly from the image plane of the display, but instead extends obliquely from the image plane of the display. In further embodiments, the lane may be curved or may be some combination of curved portions and straight portions. In still further embodiments, the lane may form a closed loop through which the viewer may travel, such as a circular or ellipsoid loop.

It should be understood that the display of three-dimensional “virtual” space is an illusion achieved by mathematically “rendering” two-dimensional images from objects in a three-dimensional “virtual space” using a “virtual camera,” just as a physical camera optically renders a two-dimensional view of real three-dimensional objects. Animation may be achieved by displaying a series of two-dimensional views in rapid succession, similar to motion picture films that display multiple still photographs per second. To generate the three-dimensional space, each object in the three-dimensional space is typically modeled as one or more polygons, each of which has associated visual features such as texture, transparency, lighting, shading, anti-aliasing, z-buffering, and many other graphical attributes. The combination of all the polygons with their associated visual features can be used to model a three-dimensional scene. A virtual camera may be positioned and oriented anywhere within the scene. In many cases, the camera is under the control of the viewer, allowing the viewer to scan objects. Movement of the camera through the three-dimensional space results in the creation of animations that give the appearance of navigation by the user through the three-dimensional environment.

A software graphics engine may be provided which supports three-dimensional scene creation and manipulation. A graphics engine generally includes one or more software modules that perform the mathematical operations necessary to “render” the three-dimensional environment, which means that the graphics engine applies texture, transparency, and other attributes to the polygons that make up a scene. Graphic engines that may be used in connection with the present invention include Gamebryo, manufactured by Emergent Game Technologies of Calabasas, Calif., the Unreal Engine, manufactured by Epic Games, and Renderware, manufactured by Criterion Software of Austin, Tex. In other embodiments, a proprietary graphic engine may be used. In many embodiments, a graphics hardware accelerator may be utilized to improve performance. Generally, a graphics accelerator includes video memory that is used to store image and environment data while it is being manipulated by the accelerator.

In other embodiments, a three-dimensional engine may not be used. Instead, a two-dimensional interface may be used. In such an embodiment, video footage of a band can be used in the background of the video game. In others of these embodiments, traditional two-dimensional computer-generated representations of a band may be used in the game. In still further embodiments, the background may only slightly related, or unrelated, to the band. For example, the background may be a still photograph or an abstract pattern of colors. In these embodiments, the lane may be represented as a linear element of the display, such as a horizontal, vertical or diagonal element.

Still referring to FIG. 1B The player associated with the middle lane 103 (drummer) may also use a specialized controller to interact with the game that simulates a drum kit, such as the DrumMania drum controller, manufactured by Topway Electrical Appliance Co., Ltd. of Shenzhen, China. In some embodiments, the drum controller provides four drum pads and a kick drum pedal. In other embodiments, the drum controller surrounds the player, as a “real” drum kit would do. In still other embodiments, the drum controller is designed to look and feel like an analog drum kit. In these embodiments, a cue may be associated with a particular drum. The player strikes the indicated drum when the cue 128 passes under the target marker 142, to successfully execute cue 128. In other embodiments, a player may use a standard game controller to play, such as a DualShock game controller, manufactured by Sony Corporation.

Referring back to FIG. 1A, in some embodiments, improvisational or “fill” sections may be indicated to a drummer or any other instrumentalist. In FIG. 1A, a drum fill is indicated by long tubes 130 filling each of the sub-lanes of the center lane which corresponds to the drummer.

In some embodiments, a player is associated with a “turntable” or “scratch” track. In these embodiments, the player may provide input using a simulated turntable such as the turntable controller sold by Konami Corporation.

Local play may be competitive or it may be cooperative. Cooperative play is when two or more players work together in an attempt to earn a combined score. Competitive play may be when a player competes against another player in an attempt to earn a higher score. In other embodiments, competitive play involves a team of cooperating players competing against another team of competing players in attempt to achieve a higher team score than the other team. Competitive local play may be head-to-head competition using the same instrument, head-to-head competition using separate instruments, simultaneous competition using the same instrument, or simultaneous competition using separate instruments. In some embodiments, rather than competing for a high score, players or teams may compete for the best crowd rating, longest consecutive correct note streak, highest accuracy, or any other performance metric. In some embodiments, competitive play may feature a “tug-of-war” on a crowd meter, in which each side tries to “pull” a crowd meter in their direction by successfully playing a song. In one embodiment, a limit may be placed on how far ahead one side can get in a competitive event. In this manner, even a side which has been significantly outplayed in the first section of a song may have a chance late in a song to win the crowd back and win the event.

In one embodiment, competition in local play may involve two or more players using the same type of instrument controller to play the game, for example, guitar controllers. In some embodiments, each player associates themselves with a band in order to begin play. In other embodiments, each player can simply play “solo,” without association with a band. In these embodiments, the other instruments required for performance of a musical composition are reproduced by the gaming platform. Each of the players has an associated lane and each player is alternately required to perform a predetermined portion of the musical composition. Each player scores depending on how faithfully he or she reproduces their portions of the musical composition. In some embodiments, scores may be normalized to produce similar scores and promote competition across different difficulty levels. For example, a guitarist on a “medium” difficulty level may be required to perform half of the notes as a guitarist on a “hard” difficulty level and, as such, should get 100 points per note instead of 50. An additional per-difficulty scalar may be required to make this feel “fair.”

This embodiment of head-to-head play may be extended to allow the players to use different types of game controllers and, therefore, to perform different portions of the musical composition. For example, one player may elect to play using a guitar-type controller while a second player may play using a drum-type controller. Alternatively, each player may use a guitar-type controller, but one player elects to play “lead guitar” while the other player elects to play “rhythm guitar” or, in some embodiments, “bass guitar.” In these examples, the gaming platform reproduces the instruments other than the guitar when it is the first player's turn to play, and the lane associated with the first player is populated with gems representing the guitar portion of the composition. When it is time for the second player to compete, the gaming platform reproduces the instruments other than, for example, the drum part, and the second player's lane is populated with gems representing the drum portion of the musical composition. In some of these embodiments, a scalar factor may be applied to the score of one of the player's to compensate for the differences in the parts of the musical composition.

In still other embodiments, the players may compete simultaneously, that is, each player may provide a musical performance at the same time as the other player. In some embodiments, both players may use the same type of controller. In these embodiments, each player's lane provides the same pattern of cues and each player attempts to reproduce the musical performance identified by those elements more faithfully than the other player. In other embodiments, the players use different types of controllers. In these embodiments, one player attempts to reproduce one portion of a musical composition while the other player tries to represent a different portion of the same composition.

In any of these forms of competition, the relative performance of a player may affect their associated avatar. For example, the avatar of a player that is doing better than the competition may, for example, smile, look confident, glow, swagger, “pogo stick,” etc. Conversely, the losing player's avatar may look depressed, embarrassed, etc.

Instead of competing, the players may cooperate in an attempt to achieve a combined score. In these embodiments, the score of each player contributes to the score of the team, that is, a single score is assigned to the team based on the performance of all players. As described above, a scalar factor may be applied to the score of one of the player's to compensate for the differences in the parts of the musical composition.

Still referring to FIG. 1A, an indicator of the performance of a number of players on a single performance meter 180 is shown. In brief overview, each of the players in a band may be represented by an icon 181 182. In the figure shown the icons 181 182 are circles with graphics indicating the instrument the icon corresponds to. For example, the icon 181 contains a microphone representing the vocalist, while icon 182 contains a drum set representing the drummer. The position of a player's icon on the meter 180 indicates a current level of performance for the player. A colored bar on the meter may indicate the performance of the band as a whole.

A single meter 180 may be used to display the performance level of multiple players as well as a band as a whole. Although the meter shown displays the performance of 4 players and a band as a whole, in other embodiments, any number of players or bands may be displayed on a meter, including two, three, four, five, six, seven, eight, nine, or ten players, and any number of bands.

The meter 180 may indicate any measure of performance, and performance may be computed in any manner. In some embodiments, the meter 180 may indicate a weighted rolling average of a player's performance. For example, a player's position on the meter may reflect a percentage of notes successfully hit, where more recent notes are weighted more heavily than less recent notes. In another embodiment, a player's position on the meter may be calculated by computing a weighted average of the player's performance on a number of phrases. In some embodiments, a player's position on the meter may be updated on a note-by-note basis. In other embodiments, a player's position on the meter may be updated on a phrase-by-phrase basis. The meter may also indicate any measure of a band's performance. In some embodiments, the meter may display the band's performance as an average of each of the players' performances. In other embodiments, the indicated band's performance may comprise a weighted average in which some players' performances are more heavily weighted.

In some embodiments, the meter 180 may comprise subdivisions which indicate relative levels of performance. For example, in the embodiment shown, the meter 140 is divided roughly into thirds, which may correspond to Good, Average, and Poor performance.

In some embodiments, a player or players in a band may “fail” a song if their performance falls to the bottom of the meter. In some embodiments, consequences of failing a song may include being removed from the rest of the song. In these embodiments, a player who has failed may have their lane removed from the display, and the audio corresponding to that player's part may be removed. In some embodiments, if a single member of a band fails a song, the band may consequently fail the song. In other embodiments, if a member of a band fails a song, one or more other members of the band may continue playing. In still other embodiments, one or more other members of a band may reinstate the failed player.

The icons 181, 182 displayed to indicate each player may comprise any graphical or textual element. In some embodiments, the icons may comprise text with the name of one or more of the players. In another embodiment the icon may comprise text with the name of the instrument of the player. In other embodiments, the icons may comprise a graphical icon corresponding to the instrument of the player. For example, an icon containing a drawing of a drum 182 may be used to indicate the performance of a drummer.

The overall performance of the band may be indicated in any manner on the meter 180. In the embodiment shown, a filled bar 180 indicates the band's performance as a whole. In other embodiments, the band's performance may be represented by an icon. In some embodiments, individual performances may not be indicated on a meter, and only the performance of the band as a whole may be displayed.

Although described above in the context of a single player providing a single type of input, a single player may provide one or more types of input simultaneously. For example, a single player providing instrument-based input (such as for a lead guitar track, bass guitar track, rhythm guitar track, keyboard track, drum track, or other percussion track) and vocal input simultaneously.

Still referring to FIG. 1A, meters 150 151 may be displayed for each player indicating an amount of stored bonus. The meters may be displayed graphically in any manner, including a bar, pie, graph, or number. In some embodiments, each player may be able to view the meters of remote players. In other embodiments, only bonus meters of local players may be shown. Bonuses may be accumulated in any manner including, without limitation, by playing specially designated musical phrases, hitting a certain number of consecutive notes, or by maintaining a given percentage of correct notes.

In some embodiments, if a given amount of bonuses are accumulated, a player may activate the bonus to trigger an in-game effect. An in-game effect may comprise a graphical display change including, without limitation, an increase or change in crowd animation, avatar animation, performance of a special trick by the avatar, lighting change, setting change, or change to the display of the lane of the player. An in-game effect may also comprise an aural effect, such as a guitar modulation, including feedback, distortion, screech, flange, wah-wah, echo, or reverb, a crowd cheer, an increase in volume, and/or an explosion or other aural signifier that the bonus has been activated. An in-game effect may also comprise a score effect, such as a score multiplier or bonus score addition. In some embodiments, the in-game effect may last a predetermined amount of time for a given bonus activation.

In some embodiments, bonuses may be accumulated and/or deployed in a continuous manner. In other embodiments, bonuses may be accumulated and/or deployed in a discrete manner. For example, instead of the continuous bar shown in FIG. 1A, a bonus meter may comprise a number of “lights” each of which corresponds to a single bonus earned. A player may then deploy the bonuses one at a time.

In some embodiments, bonus accumulation and deployment may be different for each simulated instrument. For example, in one embodiment only the bass player may accumulate bonuses, while only the lead guitarist can deploy the bonuses.

FIG. 1A also depicts score multiplier indicators 160, 161. A score multiplier indicator 160, 161 may comprise any graphical indication of a score multiplier currently in effect for a player. In some embodiments, a score multiplier may be raised by hitting a number of consecutive notes. In other embodiments, a score multiplier may be calculated by averaging score multipliers achieved by individual members of a band. For example, a score multiplier indicator 160 161 may comprise a disk that is filled with progressively more pie slices as a player hits a number of notes in a row. Once the player has filled the disk, the player's multiplier may be increased, and the disk may be cleared. In some embodiments, a player's multiplier may be capped at certain amounts. For example, a drummer may be limited to a score multiplier of no higher than 4×. Or for example, a bass player may be limited to a score multiplier of no higher than 6×.

In some embodiments, a separate performance meter (not shown) may be displayed under the lane 220 of each player. This separate performance meter may comprise a simplified indication of how well the player is doing. In one embodiment, the separate performance meter may comprise an icon which indicates whether a player is doing great, well, or poorly. For example, the icon for “great” may comprise a hand showing devil horns, “good” may be a thumbs up, and “poor” may be a thumbs down. In other embodiments, a player's lane may flash or change color to indicate good or poor performance.

Each player may use a gaming platform in order to participate in the game. In one embodiment, the gaming platform is a dedicated game console, such as: PLAYSTATION2, PLAYSTATION3, or PLAYSTATION PERSONAL, manufactured by Sony Corporation; DREAMCAST, manufactured by Sega Corp.; GAMECUBE, GAMEBOY, GAMEBOY ADVANCE, or WII, manufactured by Nintendo Corp.; or XBOX or XBOX360, manufactured by Microsoft Corp. In other embodiments, the gaming platform comprises a personal computer, personal digital assistant, or cellular telephone. In some embodiments, the players associated with avatars may be physically proximate to one another. For example, each of the players associated with the avatars may connect their respective game controllers into the same gaming platform (“local play”).

In some embodiments, one or more of the players may participate remotely. FIG. 1C depicts a block diagram of a system facilitating network play of a rhythm action game. As shown in FIG. 1C, a first gaming platform 100a and a second gaming platform 100b communicate over a network 196, such as a local area network (LAN), a metropolitan area network (MAN), or a wide area network (WAN) such as the Internet or the World Wide Web. The gaming platforms connect to the network through one of a variety of connections including standard telephone lines, LAN or WAN links (e.g., T1, T3, 56 kb, X.25), broadband connections (e.g., ISDN, Frame Relay, ATM), and wireless connections (e.g., 802.11a, 802.11g, Wi-Max). The first gaming platform 100a and the second gaming platform 100b may be any of the types of gaming platforms identified above. In some embodiments, the first gaming platforms 100a and the second gaming platform 100b are of different types.

When a networked multiplayer game session begins at the direction of one of the players, that player's gaming platform 100a (the “host”) transmits a “start” instruction to all other gaming platforms participating in the networked game, and the game begins on all platforms. A timer begins counting on each gaming platform, each player's game cues are displayed, and each player begins attempting to perform the musical composition.

Gameplay on gaming platform 100a is independent from game play on gaming platform 100b, except that each player's gaming platform contains a local copy of the musical event data for all other players. The timers on the various gaming platforms communicate with each other via the network 196 to maintain approximate synchrony using any number of the conventional means known in the art.

The gaming platforms 100a, 100b also continually transmit game score data to each other, so that each system (and player) remains aware of the game score of all other systems (and players). Similarly, this is accomplished by any number of means known in the art. Note that this data is not particularly timing sensitive, because if there is momentary disagreement between any two gaming platforms regarding the score (or similar game-related parameters), the consequences to gameplay are negligible.

In one embodiment, as each player plays the game at their respective location, an analyzer module 180a, 180b on that player's gaming platform 100a, 100b continually extracts data from an event monitor 185a, 185b regarding the local player's performance, referred to hereafter as “emulation data”. Emulation data may include any number of parameters that describe how well the player is performing. Some examples of these parameters include:
whether or not the most recent event type was a correctly-played note or an incorrectly-played noted;
a timing value representing the difference between actual performance of the musical event and expected performance of the musical event;
a moving average of the distribution of event types (e.g., the recent ratio of correct to incorrect notes);
a moving average of the differences between the actual performance of musical events and the expected performance times of the musical events; or
a moving average of timing errors of incorrect notes.

Each analyzer module 180a, 180b continually transmits the emulation data it extracts over the network 196 using transceiver 190a, 190b; each event monitor 185a, 185b continually receives the other gaming platform's emulation data transmitted over the network 196.

In one embodiment, the emulation data essentially contains a statistical description of a player's performance in the recent past. The event monitor 185a, 185b uses received emulation data to create a statistical approximation of the remote player's performance.

In one particular example, an incoming emulation parameter from a remote player indicates that the most recent remote event was correctly reproduced. When the local event monitor 185a, 185b reaches the next note in the local copy of the remote player's note data, it will respond accordingly by “faking” a successfully played note, triggering the appropriate sound. That is, the local event monitor 185a, 185b will perform the next musical event from the other players' musical event data, even though that event was not necessarily actually performed by the other player's event monitor 185a, 185b. If instead the emulation parameter had indicated that the most recent remote event was a miss, no sound would be triggered.

In another particular example, an incoming emulation parameter from a remote player indicates that, during the last 8 beats, 75% of events were correctly reproduced and 25% were not correctly reproduced. When the local event monitor 185a reaches the next note in the local copy of the remote player's note data, it will respond accordingly by randomly reproducing the event correctly 75% of the time and not reproducing it correctly 25% of the time.

In another particular example, an incoming emulation parameter from a remote player indicates that, during the last 4 beats, 2 events were incorrectly performed, with an average timing error of 50 “ticks.” The local event monitor 185a, 185b will respond accordingly by randomly generating incorrect events at a rate of 0.5 misses-per-beat, displacing them in time from nearby notes by the specified average timing error.

The above three cases are merely examples of the many types of emulation parameters that may be used. In essence, the remote player performances are only emulated (rather than exactly reproduced) on each local machine.

In this embodiment, the analyzer module 180a, 180b may extract musical parameters from the input and transmit them over a network 196 to a remote gaming platform. For example, the analyzer module 180a, 180b may simply transmit the input stream over a network 196 or it may extract the information into a more abstract form, such as “faster” or “lower.” Although described in the context of a two-player game, the technique may be used with any number of players.

Still referring to FIG. 1C, in another embodiment, analyzer module 180a, 180b extracts data from the event monitor 185a, 185b regarding the local player's performance. In this embodiment, however, the extracted data is transmitted over the network 550 using the transceiver 190a, 190b. When the analyzer 180a, 180b receives the transmitted data, it generates an emulation parameter representing the other player's musical performance and provides the locally-generated emulation parameter to the event monitor 185a, 185b, as described above. One advantage of this embodiment is that each player may locally set their preference for how they want the event monitor 185a, 185b to act on emulation parameters.

In other embodiments, the transmitted data is associated with a flag that indicates whether the transmitted data represents a successfully executed musical event or an unsuccessfully executed musical event. In these embodiments, the analyzer 180a, 180b provides a locally-generated emulation parameter to the event monitor 185a, 185b based on the flag associated with the transmitted data.

One unusual side effect of these techniques is that each local player does not hear an exact reproduction of the remote players' performances; only a statistical approximation. However, these statistical approximations have two countervailing positive attributes: because they are synchronized to the local player's timer and the local copy of the remote players' note data, they are synchronous with the local player's performance; and while not exact reproductions, they are “close enough” to effectively communicate to the local player the essence of how well the remote players are performing musically. In this model, delays in the transmission of the data over the network 196 do not have the intolerable side effect of causing cacophonous asynchronicity between the note streams triggering sounds on each player's local system.

In other embodiments, a central server may be used to facilitate communication between the gaming platforms 100a, 100b. Extraction of emulation parameters is performed, as described above. The server distributes data, whether music performance data or emulation parameter data, to all other gaming platforms participating in the current game. In other embodiments, the server may store received data for use later. For example, a band may elect to use the stored data for the performance of a band member who is unavailable to play in a specific game.

Referring now to FIG. 1D, one embodiment of a screen display for remote multiplayer play is shown. The embodiment of the screen display shown in FIG. 1D may be used for head-to-head play, for simultaneous competition, and for cooperative play. As shown in FIG. 1D, a local player's lane 105 is shown larger than the lanes 106 107 of two remote players. The avatars for remote players may appear normally on stage in a similar manner as if the avatars represented local players. In other embodiments, the lanes may be displayed in a similar manner for both local multiplayer and remote multiplayer. In still other embodiments, in remote multiplayer, only the local player or player's avatars may be shown.

As shown in FIG. 1D, the lanes 106, 107 associated with the remote players are shown smaller than the local player's lane 640. In other embodiments, the lanes of one or more remote players may be graphically distinguished in any other way. For example, the remote players' lanes may be shown translucently. Or for example, the remote players' lanes may have a higher transparency than local player's lanes. Or the remote players' lanes may be shown in grayscale, or in a different screen location than local players' lanes. In some embodiments, a remote vocalist's lane may not be shown at all, and instead only the lyrics of the song may be displayed.

In some embodiments, multiple players participate in an online face-off between two bands. A “band” is two or more players that play in a cooperative mode. In some embodiments, the two bands need to have the same types of instruments at the same difficulty level selection, i.e., a guitarist playing on “hard” and a bassist playing on “medium” playing against a guitarist playing on “hard” and a bassist playing on “medium.” In other embodiments, the two bands still need to have the same types of instruments but the difficulty selections can be different: Players participating at a lower difficulty level simply have fewer gems to contribute to the overall score. The song to be played may be selected after the teams have been paired up. Alternatively, a band may publish a challenge to play a particular song and a team may accept the challenge.

For example, a local group of players may formed a band and give their band a name (“The Freqs.”). Each of the four players in the “The Freqs” is local to one another. They may then competing against a team of players located remotely, who have formed a band called “The Champs.” In some cases “The Champs” may each be local to one another. In other cases, members of “The Champs” my be remote to each other. Each player in “The Freqs” and “the Champs” may see a display similar to FIG. 1A or FIG. 1B. However, in some embodiments, an additional score meter may be displayed showing the score of the other band. In other embodiments any other measure and indication of performance of a band may be given. For example, in some embodiments, meters may be displayed for each band indicating relative performance, crowd engagement, percentage of notes hit, or any other metric. In some embodiments, a four-in-one meter 180 as depicted in FIG. 1A may be displayed for each band. In some embodiments, avatars from both bands may be depicted on the stage.

In some embodiments, the bands “trade” alternating portions of the musical composition to perform; that is, the performance of the song alternates between bands. In these embodiments, musical performance output from “The Champs” is reproduced locally at the gaming platform used by “The Freqs” when “The Champs” are performing. Similarly, the musical performance of “The Freqs” is reproduced remotely (using the emulation parameter technique described above) at the gaming platform of “The Champs” when “The Freqs” are performing. In other embodiments, the bands play simultaneously. In these embodiments, the displayed score may be the only feedback that “The Freqs” are provided regarding how well “The Champs” are performing.

In some particular embodiments, members of cooperating bands may be local to one another or remote from one another. Similarly, members of competing bands may be local to one another or remote from one another. In one example, each player is remote from every other player.

In some embodiments, players may form persistent bands. In these embodiments, those bands may only compete when at least a majority of the band in available online. In some of the embodiments, if a member of a persistent band in not online and the other band members want to compete, a gaming platform may substitute for the missing band member. Alternatively, a player unaffiliated with the band may substitute for the missing band member. In still other embodiments, a stream of emulation parameters stored during a previous performance by the missing band member may be substituted for the player. In other embodiments, an online venue may be provided allowing players to form impromptu bands. Impromptu bands may dissolve quickly or they may become persistent bands.

Although FIGS. 1A, 1B and 1D show a band comprising one or more guitars, a drummer, and a vocalist, a band may comprise any number of people playing any musical instruments. Instruments that may be simulated and played in the context of a game may include, without limitation, any percussion instruments (including cymbals, bell lyre, celeste, chimes, crotales, glockenspiel, marimba, orchestra bells, steel drums, timpani, vibraphone, xylophone, bass drum, crash cymbal, gong, suspended cymbal, tam-tam, tenor drum, tom-tom, acme siren, bird whistle, boat whistle, finger cymbals, flex-a-tone, mouth organ, marching machine, police whistle, ratchet, rattle, sandpaper blocks, slapstick, sleigh bells, tambourine, temple blocks, thunder machine, train whistle, triangle, vibra-slap, wind machine, wood block, agogo bells, bongo drum, cabaca, castanets, claves, conga, cowbell, maracas, scraper, timbales, kick drum, hi-hat, ride cymbal, sizzle cymbal, snare drum, and splash cymbal), wind instruments (including piccolo, alto flute, bass flute, contra-alto flute, contrabass flute, subcontrabass flute, double contrabass flute, piccolo clarinet, sopranino clarinet, soprano clarinet, basset horn, alto clarinet, bass clarinet, contra-alto clarinet, contrabass clarinet, octocontra-alto clarinet, octocontrabass clarinet, saxonette, soprillo, sopranino saxophone, soprano saxophone, conn-o-sax, clar-o-sax, saxie, mezzo-soprano saxophone, alto saxophone, tenor saxophone, baritone saxophone, bass saxophone, contrabass saxophone, subcontrabass saxophone, tubax, aulochrome, tarogato, folgerphone, contrabassoon, tenoroon, piccolo oboe, oboe d'amore, English horn, French horn, oboe de caccia, bass oboe, baritone oboe, contrabass oboe, bagpipes, bugle, cornet, didgeridoo, euphonium, flugelhorn, shofar, sousaphone trombone, trumpet, tuba, accordion, concertina, harmonica, harmonium, pipe organ, voice, bullroarer, lasso d'amore, whip and siren), other stringed instruments (including harps, dulcimer, archlute, arpeggione, banjo, cello, Chapman stick, cittem, clavichord, double bass, fiddle, slide guitar, steel guitar, harpsichord hurdy gurdy, kora, koto, lute, lyre, mandola, mandolin, sitar, ukulele, viola, violin, and zither) and keyboard instruments (including accordion, bandoneon, calliope, carillon, celesta, clavichord, glasschord, harpsichord, electronic organ, Hammond organ, pipe organ, MIDI keyboard, baby grand piano, electric piano, grand piano, janko piano, toy piano, upright piano, viola organista, and spinets).

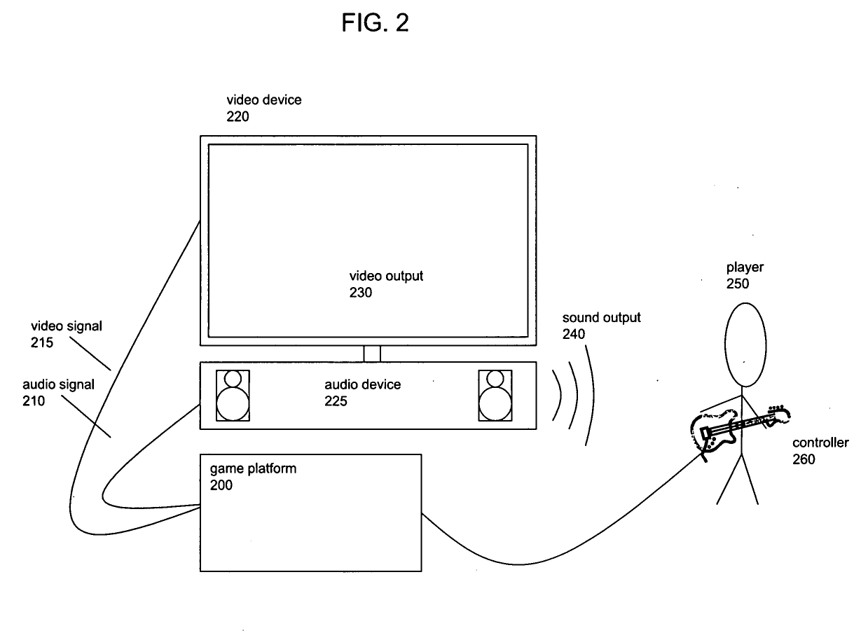

Referring now to FIG. 2, a block diagram of an example of a game platform connected to an audio/video system is shown. In brief overview, a game platform 200 sends a video signal 215 to a video device and an audio signal 210 to an audio device 225. Each of the audio and video devices produces output based on the signals that is perceptible to the player 250. The player 250 may then manipulate a controller 260 in response to the perceived output.

Still referring to FIG. 2, now in greater detail, a game platform 200 may use any method to send a video signal 215 to a video device 220, and an audio signal 210 to an audio device 225. In some embodiments, the video signal may be transmitted via cable, in other embodiments, the video signal may be transmitted wirelessly. Although the video signal 215 and audio signal 210 are shown being transmitted via separate cables, in some embodiments, the video signal 215 may be transmitted on the same cable with the audio signal 210, and may be otherwise integrated with the audio signal 210 in any manner.

The video signal 215 is received by a video device 220, which may be any device capable of displaying video output 230. Examples of video devices include, without limitation, televisions, projectors, monitors, laptop computers, and mobile devices with video screens. A video device 220 may use any display technology including, without limitation, CRT, LCD, LED, OLED, DLP, Plasma, front projection, and rear projection technologies. Although FIG. 2 shows a video device 220 separate from an audio device 225, a video and audio device may be integrated in any manner. For example, the video and audio signals may be sent to a television which displays the video and outputs audio through built-in speakers. Or for example, the video and audio signals may both be sent to a VCR, DVD player, DVR, receiver, or stereo system, which may then pass the video signal 215 to a video device 220 and the audio signal 210 to an audio device 225.

Lag may be introduced at any point between the transmission of the video signal 215 from the game platform until the video output 230 is seen by the player 250. In some cases, lag may be introduced by one or more systems, such as VCRs, DVD players, and stereo systems, that the video signal is routed through. In some cases, lag may be introduced by a video device 220. For example, many HDTV technologies, such as DLP and other rear-projection technologies, may introduce a lag of up to 100 ms between the time that a video signal is received and when it is displayed. Also, in many modern audio and video systems, signals are transmitted in a digital format. These formats may take time for a receiver to decode and display. Also, in certain systems, a signal may require significant processing after it is received to provide an enhanced signal. For example, some audio-enhancing surround-sound technologies such as Dolby Digital and THQ may add significant latency to audio processing and decoding time.

The audio signal 210 is received by an audio device 225, which may be any device capable of outputting sound in response to an audio signal 210. Examples of audio devices, include, without limitation, speakers, stereo systems, receivers, and televisions. Lag may be introduced at any point between the transmission of the audio signal 210 from the game platform until the audio output 240 is heard by the player 250. In some cases, lag may be introduced by one or more systems, such as VCRs, DVD players, and stereo systems, that the audio signal is routed through. In some cases, lag may be introduced by the audio device itself.

Given the wide variety of devices that may be connected to a game platform, there is no guarantee that the lag time of an audio system connected to a platform is similar to the lag time of a video system connected to a platform. Thus, audio and video signals output at the same time by a platform may be perceived at different times by a player. This may be true even in cases where the audio and video signals are output to a single audio/video device, such as a television with built-in speakers, as a television may not guarantee that audio and video signals received at the same time are played at the same time. A difference in audio and video lags may cause confusion in the player as the video they see may not be properly synchronized with the sounds they hear. For example, in a rhythm action-game such as described above, a player may see music targets 124 crossing a target marker 248 at a time not corresponding to the audible note to which the target corresponds. The player may become confused as to whether they should activate a controller according to the display cues or according to the audio cues.

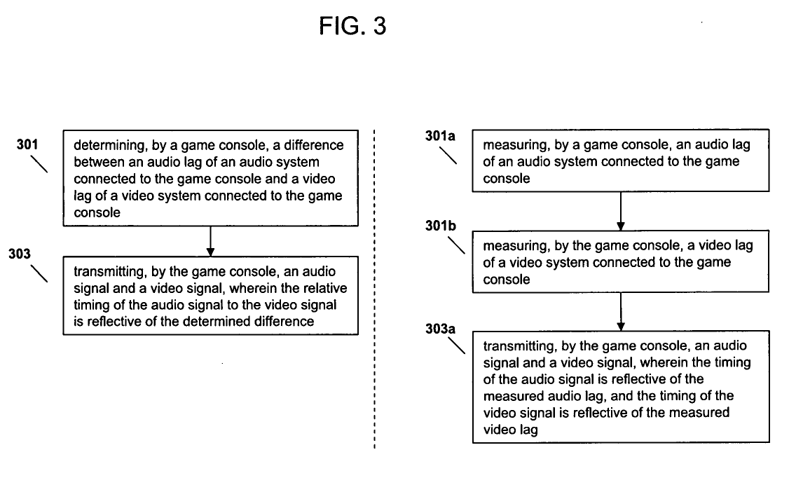

Referring now to FIG. 3, two embodiments of methods for adjusting the relative timing of audio and video signals of a video game responsive to a lag differential between an audio system and a video system connected to a game platform are shown. In brief overview, the method includes determining, by a game platform, a difference between an audio lag of an audio system connected to the game platform and a video lag of a video system connected to the game platform (step 301); and transmitting, by the game platform, an audio signal and a video signal, wherein the relative timing of the audio signal to the video signal is reflective of the determined difference (step 303). In some embodiments, the determining step (step 301) may comprise measuring, by a game platform, an audio lag of an audio system connected to the game platform (step 301a) and measuring, by the game platform, a video lag of a video system connected to the game platform (step 301b). In these embodiments, the transmitting step (step 303) may comprise transmitting, by the game platform, an audio signal and a video signal, wherein the timing of the audio signal is reflective of the measured audio lag, and the timing of the video signal is reflective of the measured video lag (step 303b).

Still referring to FIG. 3, now in greater detail, a game platform may determine a difference between an audio lag of an audio system connected to the game platform and a video lag of a video system connected to the game platform in any manner (step 301). In some embodiments, the difference may be explicitly determined by measuring and/or calculating the difference between a known audio lag and a known video lag. In other embodiments, the difference may be implicitly determined by measuring an audio lag and a video lag separately.

An audio and/or video lag of a system connected to a game platform may be determined in any manner and any order. In some embodiments, lag values may be measured during gameplay. In other embodiments, lag values may be measured by a designated series of calibration screens and/or processes. In some embodiments, lag values may be empirically measured by the game platform. In other embodiments, a game platform may accept input of lag values by a user. In some embodiments, a game platform may accept input of a type, model, and/or brand of audio and/or video system from a user. A game platform may then use the type, model, and/or brand of the audio system in connection with determining the audio and/or video lag of the system. For example, a game platform may prompt a user to enter whether their television is a CRT display, LCD display, plasma display, or rear projection display. The game platform may then use previously determined average video lag values for such televisions.

In some embodiments, an audio lag may be measured by prompting a user to respond to an audio cue. The game platform may then measure the time between when the audio signal was sent to the audio system and the time the user response was received. For example, the game platform may display a screen asking a user to press a button synchronously with a repeating beat. The game platform may compensate for or include any sources of lag besides the audio system in such a measurement including, without limitation, user reaction time, controller response time, and lag internal to the game platform, such as lag introduced by the processor or I/O drivers. For example, a game platform may measure a total time of 80ms between when a sound signal was output and the user response was received. The game platform may subtract 5ms from that value to compensate for known controller lag (e.g. the time between when a button is pressed and when the controller transmits a signal to the game platform). The game platform may subtract another 7 ms to compensate for known lag in the game platform's handling of I/O events. Thus the game platform may arrive at a value of 68 ms for the lag of the audio system connected to the game platform.

In some embodiments, a video lag may be measured by prompting a user to respond to a video cue. The game platform may then measure the time between when the video signal was sent to the video system and the time the user response was received. For example, the game platform may display a screen asking a user to press a button synchronously with a repeating flash. The game platform may compensate for or include any sources of lag besides the video system in such a measurement including, without limitation, user reaction time, controller response time, and lag internal to the game platform, such as lag introduced by the processor or I/O drivers. For example, a game platform may measure a total time of 60 ms between when a video signal was output and the user response was received. The game platform may subtract 10 ms from that value to compensate for known controller lag (e.g. the time between when a button is pressed and when the controller transmits a signal to the game platform). The game platform may subtract another 4 ms to compensate for known lag in the game platform's handling of I/O events. Thus the game platform may arrive at a value of 56 ms for the lag of the video system connected to the game platform.

One potential problem with requiring a user to respond to an audio or video cue to determine lag is the potential error introduced by human imprecision. Therefore, in some embodiments, an audio and/or video lag may be determined using a sensor. In the case of measuring audio lag, an audio sensor may be used to respond to a specific audio stimulus such as a tone burst or a noise burst. The user may be instructed to place the audio sensor in the vicinity of the speakers connected to the gaming platform. The gaming platform may then generate the audio stimulus and record the time of the generation of the stimulus. The sensor reacts to such a stimulus event by sending a response signal back to the gaming platform. The gaming platform then records the reception time of the response signal. Subtracting the response time from the generation time yields the total audio round trip time. Further subtracting all lags not related to the external audio system from the audio round trip time (such as sensor lag, input lag, I/O driver lag, etc . . . ) can result in a measurement of the audio lag.

In the case of measuring video lag, a visual sensor is used to respond to a specific video stimulus such as flashing the video screen white for a brief moment. The user is instructed to place the visual sensor in the vicinity of the video display connected to the gaming platform. The gaming platform generates the video stimulus and records the time of the onset the stimulus. The sensor reacts to such a stimulus event by sending a response signal back to the gaming platform. The gaming platform then records the reception time of the response signal. Subtracting the response time from the generation time yields the total video round trip time. Further subtracting all non-video-related lags from the video round trip time (such as sensor lag, input lag, I/O driver lag, frame buffer lag, etc . . . ) results in a measurement of the video lag.

In some embodiments, a sensor or sensors may be included within a game controller or built into the game controller. In other embodiments, a sensor or sensors may be separate from game controllers. In some embodiments of the sensor or sensors being built into a game controller, the gaming platform may instruct the controller to enter a calibration mode during the audio/video lag measurement process. In calibration mode, the sensor elements are instructed to respond to stimulus. However, when calibration mode is disabled by the gaming platform, the sensor elements do not respond to stimulus. In this way, the sensors are only active during the specific moments when calibration (meaning the determining of audio/video lag) is required.

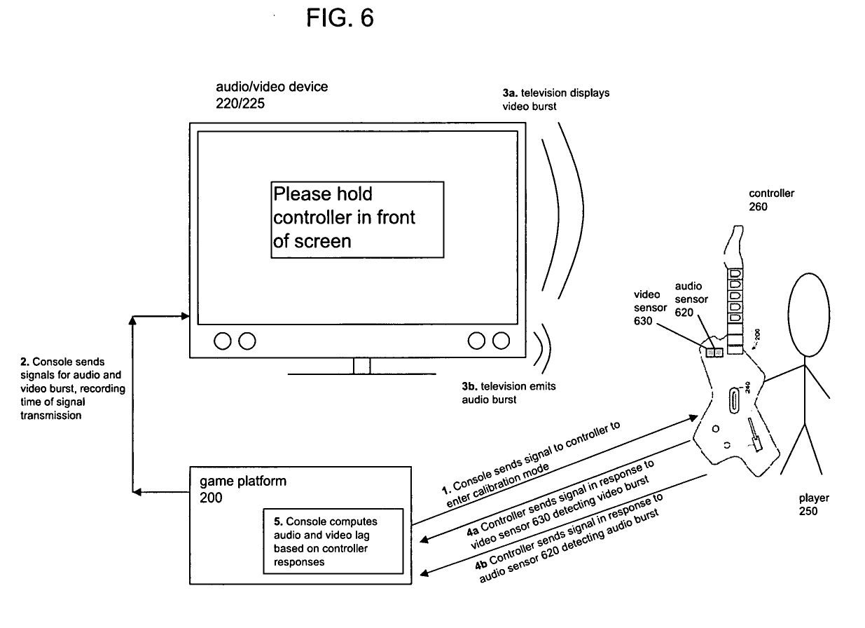

Referring now to FIG. 6, one embodiment of a process for lag calibration using a guitar controller 260 with an embedded audio sensor 620 and video sensor 630 is shown. A user may be instructed to hold the device containing the sensors in front of the screen. A game platform 200 first sends a signal to the controller to activate the sensors (step 1). The platform then sends a signal to a television 220/225 for an audio burst and a signal for a video burst, recording the time the signals were sent (step 2). In some embodiments, the signals may be sent simultaneously, in other embodiments, they may be sent sequentially. The television then outputs the video and audio burst (steps 3a, 3b) upon receiving the respective signals. As each sensor detects the respective burst, the controller sends a signal to the platform (steps 4a, 4b). The platform can then compare the time the platform received the signal from the audio sensor to the time the audio signal was sent to the television. Likewise, the platform can compare the time the platform received the signal from the video sensor to the time the video signal was sent to the television. The platform may make any appropriate adjustments to compensate for lag introduced by the sensors, the controller, or the platform itself. In some embodiments, the platform may output a single test signal for each of the audio and video sensors. In other embodiments, the platform may output a series of test signals and compute an average lag based on a number of sensor responses.

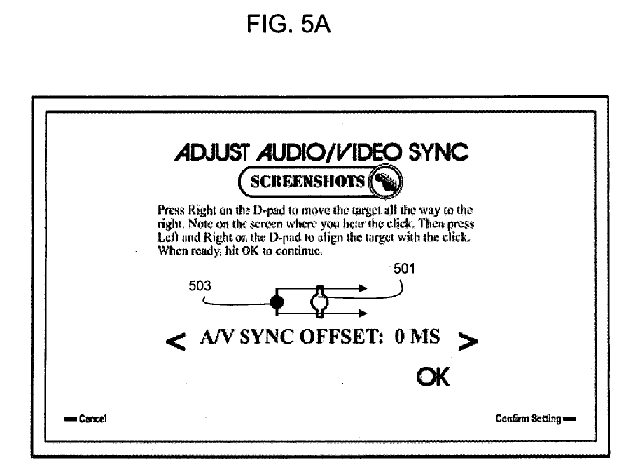

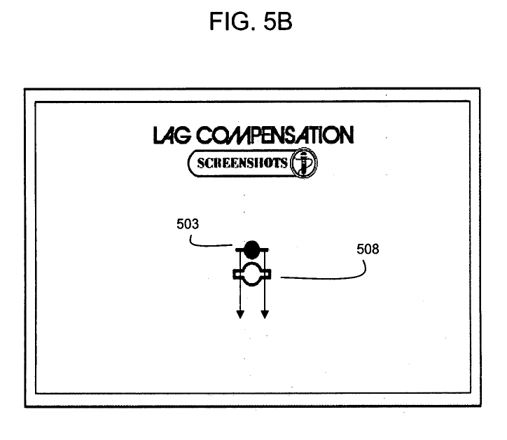

In some embodiments, a difference between an audio lag and a video lag may be measured directly. Referring back to FIG. 5A, an example calibration screen is shown in which a user is prompted to specify a relationship between a played sound and a displayed image. A sound is played at regular intervals and an object 503 repeatedly moves across the screen from left to right at the same regular intervals. The user is prompted to move a target 501 until the target resides at a place where the object crosses when the sound is played. Since the game platform knows the speed at which the object 503 is moving, the game platform can determine the difference between the audio and video lag of the external system based on the user input. For example, the audio signal and video signal may be output such that, in the case of no lag, the object 503 will be exactly in the middle of the screen when the sound is played. On a system with video lag exceeding the audio lag, the display of the moving object 503 will be delayed more than the playing of the sound, resulting in the sound being played before the moving object 503 reaches the middle of the screen. Likewise, on a system with audio lag exceeding the video lag, the display of the moving object 503 will be delayed less than the playing of the sound, resulting in the sound being played after the moving object 503 reaches the middle of the screen. Thus, depending on how far away from the center the user moves the target 501 indicating where the sound and object meet, the game platform can determine the difference between the audio and video lag of the external systems.

In some embodiments, a combined measurement of audio and video lag may be made in any manner. For example, referring ahead to FIG. 5B, an example calibration screen is shown in which a user is prompted to perform an action synchronously with both a displayed image and a played sound. In one embodiment, a moving object 503 may descend vertically towards a target 508. A beep or other sound signal may then be output by the game platform at the time the game platform outputs the video signal corresponding to the object 503 intersecting the target 508. A user may then be instructed to perform an action synchronously with the moving object 503 hitting the target 508 and the sound being played.

In one embodiment, the combined measurement may be made after a difference between audio and video lag is determined. For example, the calibration screen of FIG. 5A may be displayed to a user, allowing a game platform to measure the difference between the audio and video lag. However, the calibration screen of FIG. 5A may not provide a measurement of the total audio or video lag. That is, if the audio lag is 30 ms and the video lag is 90 ms, the calibration screen of FIG. 5A may allow the game platform to determine the lag difference is 60 ms, but may not allow the game platform to determine that an additional 30 ms of lag is introduced by both the audio and video systems. The calibration screen of FIG. 5B may then be displayed, but with the video signal transmitted by the game platform 60 ms earlier than the corresponding audio signal. A user may then perceive the audio and video signals synchronously due to the 60 ms lag differential, and respond to the signal. The game platform may then measure the lag between when the audio signal was transmitted and the user response was received to determine a combined lag offset.

After determining a difference between an audio lag and a video lag of the external audio and video systems (step 301), the game platform may transmit an audio signal and a video signal, wherein the relative timing of the audio signal to the video signal is reflective of the determined difference in any manner (step 303). “Reflective of the determined difference” may comprise any adjustment to the relative timing of the audio and video signals in response to the determined difference. In some embodiments, the audio and video signal timing may be offset by the amount of the measured lag difference. That is, if the external video lag is 50 ms and the external audio lag is 20 ms, the video signal may be transmitted 30 ms in advance of the corresponding audio signal.

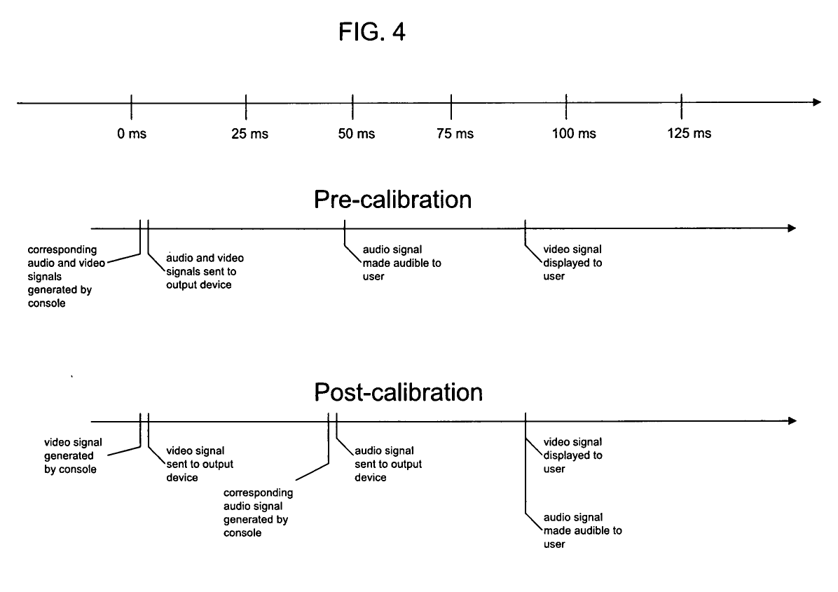

Referring now to FIG. 4, an example timeline illustrating one embodiment of transmitting an audio signal and a video signal, wherein the relative timing of the audio signal to the video signal is reflective of a determined lag difference (step 303). In the example shown, an external audio system results in an approximately 45 ms of lag between when a signal is transmitted from the game platform and when it is heard by the user. An external video system similarly causes approximately 85 ms of lag between when a video signal is transmitted from the game platform and when it is seen by the user. Thus, pre-calibration, if an audio signal and a corresponding video signal are output from the platform simultaneously, the user will perceive them approximately 40 ms apart. Post-calibration, the game platform may adjust by generating and transmitting the audio signal corresponding to a video signal 40 ms after the generation and transmitting of the video signal. This may then result in the user perceiving the signals substantially simultaneously. Although FIG. 4 shows the game platform delaying the process of generating the audio signal 40 ms, in other embodiments a game platform may use any method to offset the transmission of video and audio signals. For example, in some embodiments, the game platform may generate an audio and video signal substantially simultaneously, but cache, buffer, or otherwise store one of the signals for later transmission.

In some embodiments, a game platform may alter the relative timing of corresponding audio and video signals reflective of a lag difference (step 303) without offsetting the signals by the exact amount of a determined lag difference. In some embodiments, an audio and video signal may be offset by an approximation of a determined lag difference. For example, if a platform determines an external video system has 35 ms of additional lag than the external audio system, the platform may transmit a video signal 20 ms, 25 ms, 30 ms, 35 ms, 40 ms, 45 ms, 50 ms, or 60 ms prior to transmitting the audio signal. In some embodiments, the rough approximation may correspond to a frame rate of a video game. For example, if a game runs at 60 frames per second, a game platform may ignore lag differences substantially smaller than the time between frames. Or for example, if a game employs a given grace period for user input, the game may ignore lag differences substantially smaller than the grace period. For example, if a rhythm action game gives a player a window of ±50 ms to provide input in response to a musical gem 124 crossing a target marker, for purpose of the game, the game platform may ignore lag differentials substantially smaller than 50 ms.

In some embodiments, the relative timing between the audio and video signals transmitted by the game platform may not be constant. For example, disk accesses, processor loads, video card utilization, sound card utilization and other factors may cause the relative timing of audio and video signals to vary. In these cases, a game platform may use any techniques alter the relative timing of corresponding audio and video signals responsive to a lag difference (step 303), including without limitation altering the average relative timing, or altering a minimum and maximum range of relative timings.

In some embodiments, any of the above methods for determining or measuring lag values may determine an average lag value over a series of measurements. For example, a screen may be displayed asking a user to repeatedly strum a guitar controller in response to a displayed cue. The game platform may then compute the average delay between the transmission of the video signal comprising the displayed cue, and the user response. An average may be computed in any manner, including by mean, median, or mode. In some embodiments, an average may be computed after discarding a predetermined number of the highest and/or lowest measurements. In some embodiments, an average may be computed of measurements falling within a predetermined acceptable range.

In some embodiments, audio and/or video lag measurements may be adjusted to reflect whether the measurements were taken during gameplay situations. For example, a game platform processor, I/O system, graphics resources, and sound resources may be significantly more taxed during gameplay than during specialized configuration screens. These game platform components may introduce more lag during gameplay, and any lag measurements made outside of gameplay may be appropriately adjusted for gameplay conditions.

Although the lag calibration techniques have been described using a specific example of a rhythm action game, it should be understood that the lag calibration techniques described herein may be applicable to any gaming genre or genres including without limitation first-person shooters, combat games, fighting games, action games, adventure games, strategy games, role-playing games, puzzle games, sports games, party games, platforming games, and simulation games.

Aspects of the present invention may be provided as one or more computer-readable progra ms embodied on or in one or more articles of manufacture comprising computer readable media. The article of manufacture may be a floppy disk, a hard disk, a CD-ROM, DVD, other optical disk, a flash memory card, a PROM, a RAM, a ROM, or a magnetic tape. In general, the computer-readable progra ms may be implemented in any programming language, LISP, PERL, C, C++, PROLOG, or any byte code language such as JAVA. The software progra ms may be stored on or in one or more articles of manufacture as executable instructions. In some embodiments, portions of the software progra ms may be stored on or in one or more articles of manufacture, and other portions may be made available for download to a hard drive or other media connected to a game platform. For example, a game may be sold on an optical disk, but patches and/or downloadable content may be made available online containing additional features or functionality.

Having described certain embodiments of the invention, it will now become apparent to one of skill in the art that other embodiments incorporating the concepts of the invention may be used. Although the described embodiments relate to the field of rhythm-action games, the principles of the invention can extend to other areas that involve musical collaboration or competition by two or more users connected to a network.

We claim:

1. A method for adjusting the relative transmission times of audio and video signals of a video game, the method comprising:
a. determining, by a game platform, a difference between an audio lag of an audio system connected to the game platform and a video lag of a video system connected to the game platform; and
b. transmitting, by the game platform, an audio signal and a video signal, wherein the relative timing of the audio signal to the video signal is reflective of the determined difference.

2. The method of claim 1, wherein step (a) comprises displaying a first input screen which accepts input corresponding to a difference between an audio lag of an audio system connected to the platform and a video lag of a video system connected to the platform.

3. The method of claim 2, wherein the first input screen receives input from a user specifying a temporal relationship between a displayed image and a played sound.

4. The method of claim 2, wherein step (a) further comprises displaying a second input screen which directs a user to perform an action synchronously with at least one of a video and audio cue.

5. The method of claim 2, wherein step (a) further comprises displaying a second input screen which directs a user to perform an action synchronously with an audio cue.

6. The method of claim 1, wherein step (a) comprises: displaying a first input screen which directs a user to perform an action synchronously with an audio cue, and displaying a second input screen which directs a user to perform an action synchronously with a video cue.

7. The method of claim 1, wherein step (a) comprises:
a. outputting at least one test signal; and
b. receiving a response from a sensor indicating detection of the test signal.

8. The method of claim 7, wherein the sensor is connected to a simulated musical instrument.

9. The method of claim 1, wherein step (a) comprises determining, by a game platform, an average difference between an audio lag of an audio system connected to the platform and a video lag of a video system connected to the platform.

10. The method of claim 1, wherein the video signal comprises video of a rhythm-action game, and the audio signal comprises music of the rhythm-action game.

11. A computer readable medium having executable instructions for method for adjusting the relative transmission times of audio and video signals of a video game, the computer readable medium comprising:
executable instructions for determining, by a game platform, a difference between an audio lag of an audio system connected to the platform and a video lag of a video system connected to the platform; and
executable instructions for transmitting, by the game platform, an audio signal and a video signal, wherein the relative timing of the audio signal to the video signal is reflective of the determined difference.

12. The computer readable medium of claim 11 comprising executable instructions for displaying a first input screen which accepts input from a user specifying a difference between an audio lag of an audio system connected to the platform and a video lag of a video system connected to the platform.

13. The computer readable medium of claim 12, wherein the first input screen directs a user to specify a temporal relationship between a displayed image and a played sound.

14. The computer readable medium of claim 12, comprising executable instructions for displaying a second input screen which directs a user to perform an action synchronously with at least one of a video and audio cue.

15. The computer readable medium of claim 11 comprising executable instructions for displaying a first input screen which directs a user to perform an action synchronously with an audio cue, and displaying a second input screen which directs a user to perform an action synchronously with a video cue.

16. The computer readable medium of claim 11 comprising executable instructions for receiving input from an lag calibration device.

17. The computer readable medium of claim 11 comprising executable instructions for determining an average difference between an audio lag of an audio system connected to the platform and a video lag of a video system connected to the platform.

18. The computer readable medium of claim 11, wherein the video signal comprises video of a rhythm-action game, and the audio signal comprises music of the rhythm-action game.

19. A computer readable medium having executable instructions for calibrating the timing of transmission of audio and video signals of a video game, the computer readable medium comprising:
executable instructions for measuring, by a game platform, an audio lag of an audio system connected to the game platform;
executable instructions for measuring, by the game platform, a video lag of a video system connected to the game platform; and
executable instructions for transmitting, by the game platform, an audio signal and a video signal, wherein the timing of the audio signal is reflective of the measured audio lag, and the timing of the video signal is reflective of the measured video lag.

20. The computer readable medium of claim 19, wherein the video lag is measured independently of the audio lag.
